(19) United States
(12) Patent Application Publication
(10) Pub. No.: US 2007/0174127 A1
(43) Pub. Date: Jul. 26, 2007

(54) Method and system for adjusting the balance of account of the advertiser in a keyword advertisement

(76) Inventor: Woo Sung Lee, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/726,165

(22) Filed: Mar. 21, 2007

Related U.S. Application Data
(63) Continuation of application No. PCT/KR05/03105, filed on Sep. 16, 2005.

(30) Foreign Application Priority Data
Sep. 21, 2004 (KR) 10-2004-0075539

(51) Int. Cl. G06Q 30/00

(52) U.S. Cl. 705/14

(57) ABSTRACT

The account balance adjusting method includes the steps of maintaining an advertiser information database; extracting at least one search information associated with a keyword; determining one search information through a predetermined bidding process using the first bidding price; generating a search result list; maintaining the first bidding price and the generated search result list; receiving a selection of search information from a user; calculating predetermined advertising cost in association with the selection; and deducting the calculated advertising cost from the account balance of an advertiser, wherein the bidding process occurs at a second point in time when a predetermined period of time passes from the first point in time.

### CROSS-REFERENCE TO RELATED APPLICATIONS

This application is a continuation application under 35 U.S.C. § 365(c) of International Application No. PCT/KR2005/003105, filed Sep. 16, 2005, designating the United States, which claims the benefit of Korean Patent Application No. 10-2004-0075539 filed Sep. 21, 2004. This application incorporates herein by reference the International Application No. PCT/KR2005/003105 and the Korean Patent Application No. 10-2004-0075539 in their entirety.

### BACKGROUND

### Field

The present invention relates to a method and system for adjusting an account balance. More particularly, the present invention relates to a method and system for adjusting the account balance of an advertiser in keyword advertising which generates advertising cost by using bidding price of search information successfully accepted according to a bidding process that is performed in a predetermined point in time and maintains the generated advertising cost to be involved in a payment process with respect to the account balance by the next bidding point in time.

An operator of a keyword advertising service may charge a predetermined advertising cost to an advertiser as a sort of compensation for enabling a connection between a user and the advertiser via the user's click. The charged advertising cost is deducted from the advertiser's predetermined account.

The most representative method for calculating advertising cost in the keyword advertising service may be a method of calculating advertising cost on the basis of a bidding price associated with extraction of brief information. The calculation method of advertising cost described above is a method of receiving a bidding price from an advertiser and charging the bidding price to the advertiser as advertising cost in the case a user clicks corresponding brief information. In this instance, the bidding price is associated with a standard for determining an extraction order of brief information or a standard displaying extracted brief information.

However, the calculation of advertising cost changes according to an amount of advertising cost calculated whenever an advertiser changes a bidding price. Accordingly, the calculation of advertising cost described above has a problem that system sources are unacceptably wasted to calculate advertising cost. Also, since an amount of advertising cost constantly changes, an advertiser may not be able to estimate future advertising cost.

### SUMMARY

To solve the aforementioned problems, the present invention provides a method and system for adjusting an account balance, which can optimally save system resources spent in calculating advertising cost by receiving a new bidding price, of an advertiser in real time and applying advertising cost to a payment process generating within a certain period. In this instance, the advertising cost is calculated by using a bidding price in a predetermined point in time.

The present invention also provides a method and system for adjusting the account balance, which can meet an advertiser's demands for modification with respect to a bidding price in real time by updating the advertiser's new bidding price in a short time.

The present invention also provides a method and system for adjusting the account balance, which can more reasonably charge advertising cost by charging pre-calculated advertising cost to an advertiser in association with a user's click occurring between time intervals when a bidding process with respect to search information is performed.

To achieve the above objectives, according to an embodiment of the present invention, there is provided a method for adjusting an account balance of an advertiser in keyword advertising, the method including the steps of: maintaining an advertiser information database including a keyword, search information associated with the advertiser, designation information in a display position, a first bidding price, and the account balance of the advertiser; extracting at least one search information associated with a keyword for each display position in a first point in time, on the basis of the designation information; determining one search information displayed on each display position through a predetermined bidding process using the first bidding price with respect to the extracted search information; generating a search result list displaying the determined search information on a corresponding display position; maintaining the first bidding price associated with the determined search information and the generated search result list associated with the keyword in a search information database; receiving a selection of search information from a user with respect to the search result list provided to the user in response to the user's search request including the keyword; calculating predetermined advertising cost in association with the selection; and deducting the calculated advertising cost from the account balance of an advertiser of the selected search information, wherein the bidding process occurs in a second point in time when a predetermined period time passes from the first point in time, and the step of calculating predetermined advertising cost in association with the selection comprises the steps of: in the case the selection is inputted before the second point in time passes from the first point in time, searching for a first bidding price associated with the selected search information by referring to the search information database; and calculating the advertising cost by using the retrieved first bidding price.

One aspect of the invention provides a method of running an advertisement service associated with a search using a search term.

The method comprises: transmitting an offer for a bid for a search term for an advertisement service using the search term, wherein the advertisement service involves displaying a search result page configured to display a dynamic link configured to open a designated page and a result of a search conducted using the search term in reply to a request for the search; and receiving a first bid for the advertisement service using the search term for a first period, wherein the first bid comprises a first rate to be charged to a first account associated with the first bid for each opening of a first designated page from a search result page when the opening of the first designated page occurs during the first period, wherein the first rate is to be maintained during the first period.

The method may further comprise receiving a second bid for the advertisement service using the search term, wherein the second bid comprises a second rate to be charged for each opening of the first designated page from a search result page, wherein the second bid is received prior to expiration of the first period, wherein the second rate is not to supersede the first rate for the remainder of the first period. The second rate may be to be charged for each opening of the first designated page from a search result page that occurs during a second period following the first period. The method may further comprise transmitting data indicative of the acceptance of the first bid.

The method may further comprise: receiving a second bid for the advertisement service using the search term for a second period overlapping with the first period, wherein the second bid comprises a second rate to be charged to a second account associated with the second bid for each opening of a second designated page from a search result page when the opening of the first designated page occurs during the second period; determining that the first rate is greater than the second rate; and prioritizing the first bid and the second bid based on the determination so as to display a first dynamic link for the first designated page and a second dynamic link for the second designated page in a manner the first dynamic link appears more conspicuously than or above the second dynamic link on a search result page.

The method may further comprise: receiving, from a terminal, a search request for conducting a database search or an Internet search using the search term; transmitting, to the terminal, data for displaying a search result page comprising a search result and a first dynamic link to open the first designated page; monitoring opening of the first designated page from the search result page; and charging, to the first account, the first rate upon confirming an opening of the first designated page from the search result page.

The method may further comprise charging, to an account associated with the first bid, an amount calculated based on the first rate for openings of the first designated page from search result pages created from searches using the search term, wherein the openings occur during the first period. The calculated amount may be deducted from a balance of the account.

Another aspect of the invention provides a method of arranging for an advertisement in a search result page in reply to a search request using a search term.

The method comprises: receiving, at a terminal, an offer for a bid for a search term for an advertisement service using the search term, wherein the advertisement service involves displaying a search result page comprising a dynamic link configured to open a designated page and a result of a search conducted using the search term in reply to a request for the search; and transmitting, from the terminal, a first bid for the advertisement service using the search term for a first period, wherein the first bid comprises a first rate to be charged to an account associated with the first bid for each opening of a first designated page from a search result page when the opening of the first designated page occurs during the period, wherein the first rate is to be maintained during the period.

The method may further comprise submitting a second bid for the advertisement service using the search term for opening the first designated page, wherein the second bid comprises a second rate to be charged for each opening of the first designated page from a search result page, wherein the second bid is submitted prior to expiration of the first period, wherein the second rate is not to supersede the first rate for the remainder of the first period.

The second rate may be to be charged for each opening of the first designated page from a search result page that occurs during a second period following the first period. The method may further comprise receiving an electronic notification of charging of an amount calculated based on the first rate and a count of opening of the first designated page during the first period from search result pages created from searches using the search term.

Still another aspect of the invention provides a method of running an advertisement service associated with a search using a search term.

The method comprise: receiving, from a terminal, a search request for conducting a search using a search term; conducting a database search or an Internet search using the search term; transmitting, to the terminal, data for displaying a search result page comprising a search result and a dynamic link configured to open a designated page; monitoring opening of the designated page from the search result page by activating the dynamic link; charging, to an account associated with the designated page, the rate upon confirming an opening of the designated page from the search result page, wherein the rate is fixed during a predetermined period.

The method may further comprise calculating an advertisement charge using the rate and the number of opening the page from the search result page during the fixed period, wherein charging comprises deducting the rate from a balance of the account.

The method may further comprising, to the account, an amount calculated based on the rate for a plurality of openings of the designated page from search result pages displaying the dynamic link for the designated page when each of the plurality of openings occur during the fixed period.

Charging may comprise adding the rate to and existing advertisement charge for each opening of the designated page. Monitoring the opening of the designated page may comprise receiving a notification from the terminal that the designated page is opened by activating the dynamic link by opening the page through the search result page. Monitoring the opening of the designated page may comprise determining whether any data is transmitted from a computer associated with the designated page to the terminal.

Also, as a technical configuration for achieving the above objectives, there is provided a system for adjusting an account balance of an advertiser in keyword advertising, the system including: an advertiser information database including a keyword, search information associated with the advertiser, designation information in a display position, a first bidding price, and the account balance of the advertiser; an information extraction unit extracting at least one search information associated with a keyword in a first point in time for each display position, on the basis of the designation information; a bidding processor determining one search information displayed on each display position through a predetermined bidding process using the first bidding price with respect to the extracted search information; a list generation unit generating a search result list displaying the determined search information on a corresponding display position; a search information database recording the first bidding price in association with the determined search information, and maintaining the generated search result list in association with the keyword; an interface unit receiving a selection of search information from a user with respect to the search result list provided to the user in response to the user's search request including the keyword; and a payment control unit calculating predetermined advertising cost in association with the selection; and deducting the calculated advertising cost from the account balance of an advertiser of the selected search information, wherein the bidding process occurs in a second point in time when a predetermined period time passes from the first point in time, and the payment control unit searches for a first bidding price associated with the selected search information by referring to the search information database, in the case the selection is inputted before the second point in time passes from the first point in time.

### BRIEF DESCRIPTION OF DRAWINGS

FIG. 1 is a diagram explaining schematic operations of an account balance adjusting system according to embodiments of the present invention;

FIG. 2 is a configuration diagram illustrating an account balance adjusting system according to an exemplary embodiment of the present invention;

FIG. 3 is a diagram explaining various types of information corresponding to each search information stored on the basis of a keyword and including designation information, as an example of an advertiser information database according to embodiments of the present invention;

FIG. 4 is a diagram illustrating an example of a search information database storing search information determined by a bidding process for each display position and a search result list displaying the search information according to embodiments of the present invention;

FIG. 5 is a diagram explaining various types of information corresponding to each search information stored on the basis of a keyword and including click through rate, as another example of an advertiser information database according to embodiments of the present invention;

FIG. 6 is a flowchart explicitly illustrating an account balance adjusting method according to an exemplary embodiment of the present invention;

FIG. 7 is a diagram illustrating an example of a search information database storing a search result list displaying search information in order of extraction rankings determined by a bidding process according to embodiments of the present invention;

FIG. 8 is an internal block diagram of a general purpose computer apparatus which can be adopted to implement the account balance adjusting system according to embodiments of the present invention.

FIG. 9 is a flowchart illustrating another embodiment of an account balance adjusting system according to embodiments of the present invention;

FIG. 10 is a flowchart illustrating an example of a method for updating a second bidding price inputted from an advertiser according to an exemplary embodiment of the present invention; and

FIG. 11 is a flowchart illustrating an example of a method for selecting a bidding price associated with calculation of advertising cost according to an exemplary embodiment of the present invention.

### DETAILED DESCRIPTION OF EMBODIMENTS

A keyword advertising service generally indicates providing brief information of an advertiser corresponding to a predetermined keyword to a user who has inputted the keyword into a search engine. The keyword advertising service may display brief information of an advertiser to a user in response to the user's search request. Also, the keyword advertising service facilitates a connection between a user and an advertiser via the user's click. That is, currently, the keyword advertising service is being actively provided as a new way of advertising promotion.

In this instance, if an advertiser's demand for a bidding price is accepted and advertising cost charged to the advertiser is maintained to be the same for a certain period, system resources used to calculate advertising cost may be remarkably saved. Also, an advertiser may easily estimate future advertising cost.

Accordingly, an account balance adjusting model is needed, which can save system resources spent in calculating advertising cost and processing a payment, and guarantee the ability to estimate future advertising cost by calculating advertising cost using a bidding price in a predetermined point in time and charging the calculated advertising cost to an advertiser in association with a user's click on particular brief information generated for a certain period. Also, a keyword advertising service model is needed, which can meet an advertiser's demands for modification with respect to a bidding price by updating a new bidding price inputted from an advertiser.

Hereinafter, a method and system for adjusting an account balance of an advertiser in keyword advertising will be described with reference to the accompanying drawings.

The term ‘Display position’ used throughout the present specification is a position where search information to be provided to a user as search results which can be independently displayed on a search screen. In particular, in embodiments of the present invention, the display position becomes an object for bidding. The account balance adjusting system of the present invention receives designation information to display search information in a particular display position, from an advertiser. That is, the account balance adjusting system receives designation information ‘first display position’ from an advertiser who wants to display his or her search information in the highest position of the search screen. Accordingly, in the case of search information extracted in response to a search request, it is determined whether to display the search information in a corresponding display position through a predetermined bidding process with respect to each display position specified by the designation information. Also, in embodiments of the present invention, a display position of search information may be determined by using a bidding price of search information without a user's designation. Namely, the display position of search information may be determined based upon a predetermined extraction ranking assigned to each of search information.

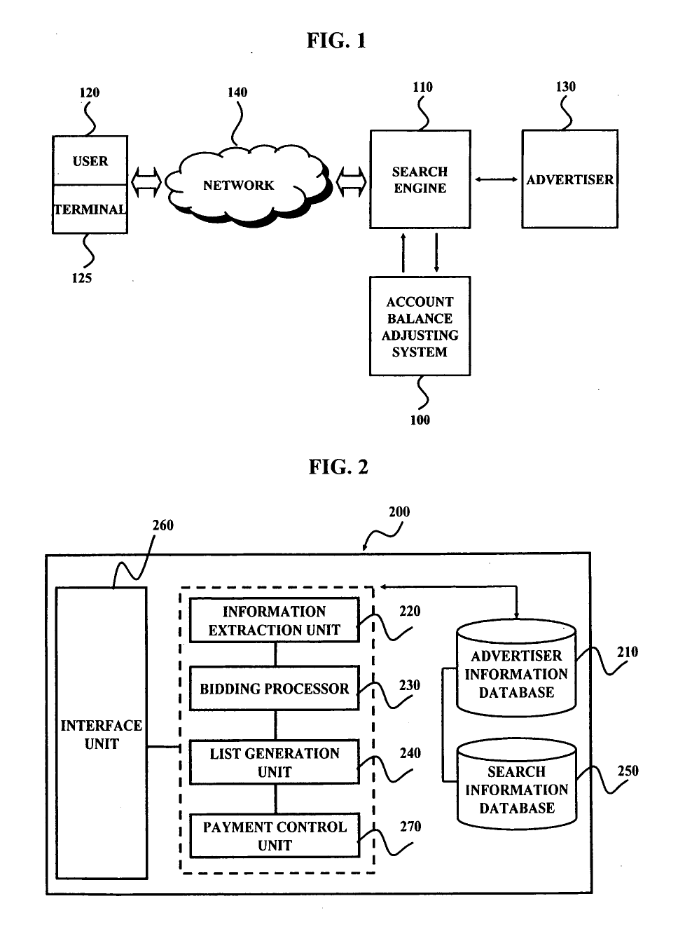

FIG. 1 is a diagram explaining schematic operations of an account balance adjusting system according to embodiments of the present invention.

An account balance adjusting system 100 functions to select a bidding price associated with calculation of advertising cost from bidding prices inputted from an advertiser 130. In this instance, the advertiser 130 receives a keyword advertising service. Also, the advertising cost is calculated by using the selected bidding price and makes a bidding process possible. In this instance, the bidding process is to deduct the advertising cost from the account balance of the advertiser 130 in real time or per a certain period, such as per minute, per hour, per day, per week, and per month.

A search engine 110 is a search program or a search web server supporting searching operation to help a user 120 to access a web page having content materials that the user 120 wants to find. The search engine 110 functions to provide the advertiser 130 with a keyword advertising service embodied by the account balance adjusting system 100. Namely, the search engine 110 provides brief information, search information. The brief information includes information desired by the user 120 in response to the user's 120 search request, and is associated with the advertiser 130.

In particular, the brief information (search information) includes predetermined link information. Accordingly, in the case the user 120 clicks brief information (search information) displayed on a terminal 125 by using a command input tool such as a mouse, the search engine 110 connects the user 120 to a web page of the advertiser 130.

The search engine 110 may be categorized as word-oriented searching or as subject-oriented searching according to a searching method. In the present specification, search information to be extracted in correspondence to an inputted keyword is controlled to be displayed in a particular display position on a search screen. That is, searching of the search engine 110 is limited to the word-oriented searching. However, this is only for convenience of description. It will be apparent to those of ordinary skills that the technical spirits of the present invention is not limited thereto.

The user 120 may be an Internet user who uses the terminal 125 to access the account balance adjusting system 100 of the present invention and inputs a predetermined keyword in the search engine 110 to generate a search request for a web page of the advertiser 130 containing desired content materials.

The advertiser 130 may be a Content Provider (CP) who operates a website designated on a network by a network address such as an IP address, a URL, a domain, etc. Also, the advertiser 130 may pay advertising cost generated in accordance with the user's 120 click on search information of an information site associated with the advertiser 130 to a system operator according to embodiments of the present invention.

The terminal 125 maintains a connection state with the account balance adjusting system 100 via a network 140 such as the Internet and the like. Also, the terminal 125 displays at least one search information extracted by searching of the search engine 110 on a search screen. The terminal 125 may be a general concept for terminals provided with a predetermined computation function by mounting a predetermined microprocessor and equipping with a predetermined memory means, such as, personal computers, handheld computers, PDAs (Personal Digital Assistants), MP3 players, electronic dictionaries, cellular phones, smart phones, and the like.

The account balance adjusting system 100 receives a bidding price associated with a keyword advertising service from the advertiser 130, stores the bidding price in association with search information of the advertiser, and calculates advertising cost to be charged to the advertiser 130 by using the bidding price. In this instance, the bidding price is associated with a bidding process with respect to the search information. Also, the calculated advertising cost is maintained and continuously applied for a predetermined period. The account balance adjusting system 100 performs a payment process by deducting the calculated advertising cost from the account balance of the advertiser 130 in association with the user's 120 click on search information. Hereinafter, a configuration of an account balance adjusting system 200 will be described with reference to FIG. 2.

FIG. 2 is a configuration diagram illustrating an account balance adjusting system according to an exemplary embodiment of the present invention.

The account balance adjusting system 200 includes an advertiser information database 210, an information extraction unit 220, a bidding processor 230, a list generation unit 240, an information search database 250, an interface unit 260, and a payment control unit 270.

The advertiser information database 210 stores a keyword, search information associated with the advertiser 130, designation information with respect to a display position, a first bidding price and an advertiser's account balance. The advertiser information database 210 functions to register and store information provided to the user 120 for a keyword advertising service on the basis of a keyword.

Namely, the advertiser information database 210 groups and stores at least one search information having the same keyword that causes the extraction of search information. Also, the advertiser information database 210 maintains bidding price information associated with calculation of advertising cost for each search information and information on the account balance of a predetermined account from which the advertising cost is deducted.

The first bidding price is the predetermined amount of a betting value inputted from the advertiser 130 who receives a keyword advertising service. The first bidding price is used as a target for comparison in a bidding processing procedure of selecting one search information to be displayed in a particular display position. Namely, the first bidding price is a bidding price associated with a bidding process. Also, the first bidding price is a bidding price different from a bidding price “inputted from the advertiser 130 for a predetermined period for which advertising cost calculated by using the first bidding price is maintained”. Namely, the first bidding price is distinguished from a second bidding price. The second bidding price will be described later.

The account balance is an amount of money maintained in a predetermined account of the advertiser 130. In the case search information associated with the advertiser 130 is selected by the user 120, the account balance adjusting system 200 deducts advertising cost from the account balance. Also, in the case an amount of money maintained in the account is less than a predetermined value, the account balance adjusting system 200 may notify the advertiser 130 of stopping of keyword advertising or may request additional deposit to the account.

The information extraction unit 220 extracts at least one search information associated with a predetermined keyword in “a first point in time” for each display position on the basis of designation information. In this instance, the first point in time may be a point in time when search information is newly arranged on a search result list. In embodiments of the present invention, a point in time when search information is newly arranged periodically occurs per a predetermined time interval. The time interval is set by an operator of the present system.

The first point in time indicates a point in time occurring right before a second point in time. Namely, the information extraction unit 220 first extracts search information at the first point in time. To update a search result list, the information extraction unit 220 extracts search information again at the second point in time after the time interval passes.

The information extraction unit 220 extracts search information stored in the advertiser information database 210 in correspondence to the same keyword. In this instance, the information extraction unit 220 extracts search information for each display position on the basis of designation information.

Also, according to another embodiment of the present invention, in the case providing of a keyword advertising service with respect to search information displayed on a current search result list is terminated or in the case a number of search information to be displayed on a search result list needs to be adjusted, the search information is extracted irrespective of the time interval. Namely, it is possible to arbitrarily determine an extraction point in time as necessary.

The bidding processor 230 determines one search information to be displayed in each display position through a bidding process using a first bidding price with respect to extracted search information. Namely, the bidding processor 230 functions to compare and select each first bidding price of search information classified for each display position. In this instance, the bidding processor 230 accepts the highest bidding price among the first bidding prices classified for a particular display position and makes it possible to display corresponding search information in the display position.

According to another embodiment of the present invention, the bidding processor 230 applies a first bidding price and a predetermined additional component to search information extracted by the information extraction unit 220. Also, the bidding processor 230 assigns an extraction ranking to the search information and determines a display position to display search information on the basis of the assigned extraction ranking. In the present embodiment, click through rate (CTR), which shows popularity among users 120 with respect to corresponding search information, is used as the additional component. For example, the bidding processor 230 may determine an extraction ranking with respect to each search information on the basis of a numerical value calculated by multiplying the first bidding price by CTR.

A display position on a search result list with respect to search results may be determined by sequentially providing search information of a comparatively higher extraction ranking in the highest portion of a search result list. Also, an advertising period of search information, a number of clicks on displayed search information, and the like may be variously set as an additional component according to a system environment.

The list generation unit 240 generates a search result list displaying determined search information in a corresponding display position. The list generation unit 240 functions to generate a search result list displaying search information determined by a bidding process in each display position. In this instance, in the case the user 120 inputs a particular keyword for a search request, the search result list is a list of results provided to the user 120 in response to the search request. The search result list is displayed on a predetermined display portion of the terminal 125 and provided to the user 120 with search information displayed in a predetermined display position.

The search information database 250 records each first bidding price in association with determined search information and maintaining a search result list generated in association with a keyword. In this instance, the keyword may be an identifiable substantive causing the search result list to be provided to the user 120 in response to a search request. Also, in the present embodiment, the keyword may be a keyword stored in the advertiser information database 210 as an extraction cause commonly associated with each search information.

In particular, the search information database 250 stores a first bidding price with respect to search results displayed on a search result list, and makes the stored first bidding price involved in calculating advertising cost to be paid for a predetermined period interval (from a first point in time to just prior to a second point in time). In this instance, the first bidding price is stored in the advertiser information database 210 at the first point in time.

The interface unit 260 receives a selection of search information from the user 120, with respect to a search result list. In this instance, the search result list is provided to the user 120 in response to the user's 120 search request including a keyword. Namely, in the case a search request is received from the user 120, the interface unit 260 functions to search the search information database 250 for a search result list corresponding to a keyword inputted in the search engine 110, provide the user 120 with the retrieved search result list, and receive a signal associated with the user's 120 click on particular search information from the terminal 125.

The payment control unit 270 calculates predetermined advertising cost in association with a selection and deducts the calculated advertising cost from the account balance of the advertiser 130 of the selected search information. In this instance, advertising cost is a concept of compensation for connecting the user 120 to the advertiser's 130 web page according to the user's 120 click on search information. In the present embodiment, the payment control unit 270 calculates advertising cost by using a first bidding price maintained in the search information database 250. In this instance, the advertising cost may be any one of predetermined cost per display according to providing the user 120 with a search result list including the search information, predetermined cost per purchase according to a successfully completed purchase by the user 120 who has been connected to an advertiser, and cost per click according to a one-time click of the user 120 with respect to the search information.

In particular, in the case the user's 120 selection is inputted before the second point in time (point in time for the next bidding process to begin from the first point in time (point in time in which a previous bidding process began), the payment control unit 270 searches for a first bidding price associated with the selected search information by referring to the search information database 250. Namely, the payment control unit 270 controls advertising cost between two points in time, when a bidding process occurs, to be calculated by using the first bidding price maintained in the search information database 250.

Accordingly, according to the present embodiment of the present invention, a bidding price (second bidding price) inputted from the advertiser 130 is stored in the advertiser information database 210 and continuously updated. Advertising cost to be charged to the advertiser 130 is calculated by using a bidding price (first bidding price). Also, the calculated advertising cost is maintained to just prior to a second point in time from a first point in time.

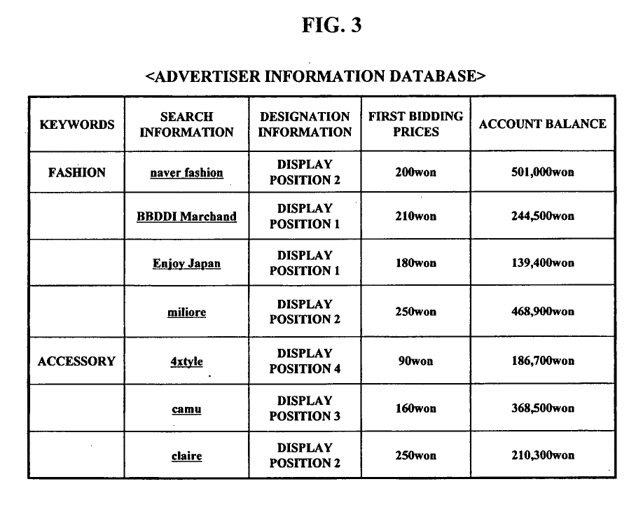

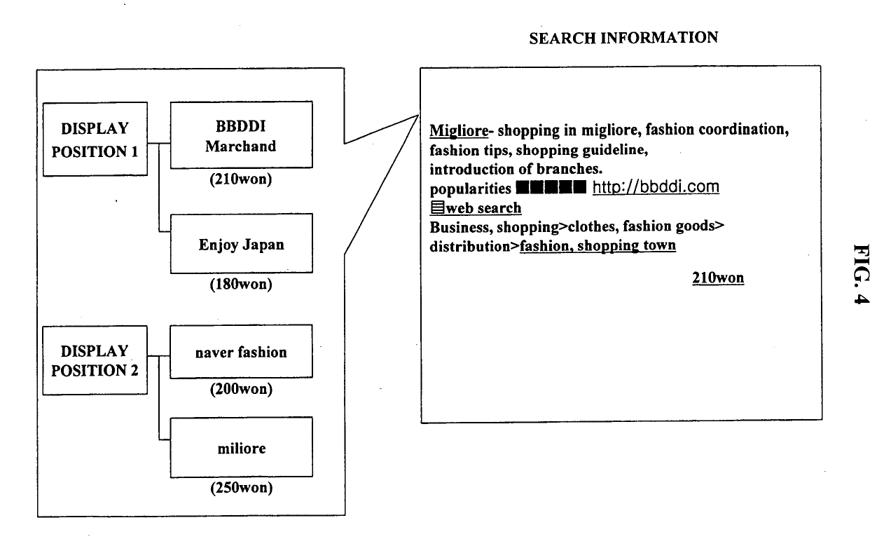

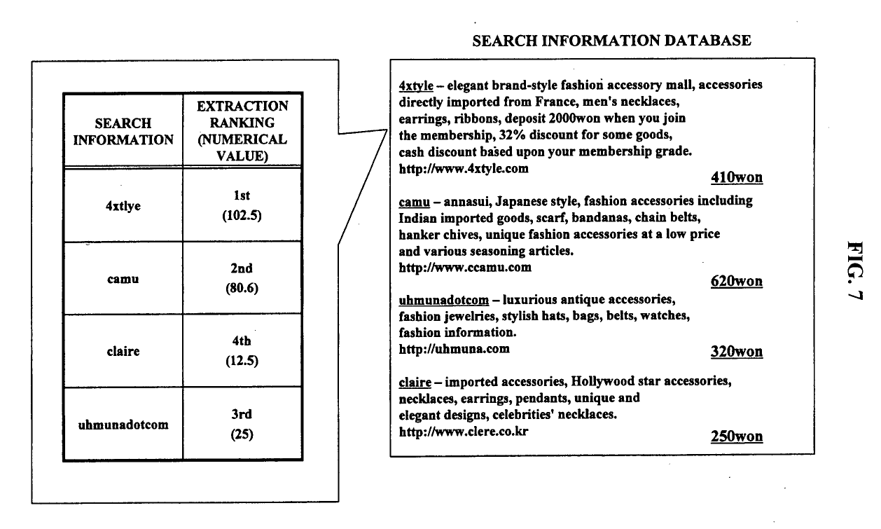

Hereinafter, adjustment of the account balance and calculation of advertising cost by using the account balance adjusting system 200 will be described with reference to FIGS. 3 and 7.

FIG. 3 is a diagram explaining various types of information corresponding to each search information stored on the basis of a keyword and including designation information, as an example of an advertiser information database according to embodiments of the present invention.

As described above, the advertiser information database 210 stores 1) designation information with respect to a display position of search information, 2) a first bidding price associated with a bidding process with respect to search information, and 3) information on the account balance associated with a keyword, in association with each search information.

The account balance increases according to a predetermined account balance charging signal from the advertiser 130 or decreases by deducting advertising cost. Also, the account balance may be updated in real time.

Also, search information is one item of search results generated in response to a search request. In this instance, the search request is generated by the user 120 inputting a keyword in the search engine 110. One search information may include brief information on a web site being advertised by the advertiser 130, such as a title of contents, a summary thereof, a network address, and the like.

In FIG. 3, the advertiser information database 210 groups and stores at least one search information (a title of contents) on the basis of keywords, ‘fashion’ and ‘accessory’. In this case, designation information, a first bidding price, and information on the account balance correspond to each search information. Referring to FIG. 3, search information ‘naver fashion’ grouped in the keyword ‘fashion’ is associated with designation information ‘display position 2’, first bidding price ‘200 won’, and account balance ‘501,000 won’.

Namely, the advertiser 130 of the search information ‘naver fashion’ demands his or her search information to be displayed in the second highest display position on a search screen. Also, the advertiser 130 has inputted the maximum allowable cost ‘200 won’ as advertising cost to be calculated at a point in time when the user 120 clicks on search information. The designation information, a first bidding price or the account balance with respect to search information may be received on the basis of the advertiser's 130 arbitrary decision and updated in the advertiser information database 210 under a certain modification condition.

FIG. 4 is a diagram illustrating an example of a search information database storing search information determined by a bidding process for each display position and a search result list displaying the search information according to embodiments of the present invention.

The information extraction unit 220 extracts search information by referring to the advertiser information database 210 at a first point in time. In this instance, the search information is stored on the basis of a predetermined keyword. Also, the information extraction unit 220 classifies search information for each particular display position according to designation information of each search information and records the classified search information in a predetermined bidding field.

In FIG. 4, search information ‘BBDDI Marchand’ and ‘Enjoy Japan’ having ‘display position 1’ as designation information are recorded in the same bidding field. Also, search information ‘naver fashion’ and ‘miliore’ having ‘display position 2’ as designation information are recorded in the same bidding field. After this, the bidding processor 230 performs a bidding process with respect to search information recorded in the bidding field. Through comparison between first bidding prices of search information, the bidding processor 230 accepts search information ‘BBDDI Marchand’ for ‘display position 1‘and search information ’ miliore’ for ‘display position 2’.

Also, the search information database 250 maintains a search result list displaying search information determined through a bidding process in a corresponding display position. In particular, the search information database 250 stores a first bidding price used for the bidding process, in correspondence to search information displayed on the search result list. The first bidding price is used to calculate advertising cost via the payment control unit 270. The calculated advertising cost is deducted from the account balance of the advertiser 130 prior a second point in time when next search information is extracted. In particular, the account balance adjusting system 200 updates only a first bidding price recorded in the advertiser information database 210 with respect to a bidding price inputted from the advertiser 130 from a first point in time to just prior to a second point in time. Accordingly, the account balance adjusting system 200 maintains advertising cost calculated at each point in time which encompasses a predetermined period (from the first point in time to just before the second point in time). In this case, the first point in time is when search information is extracted and the second point in time is when next search information is extracted.

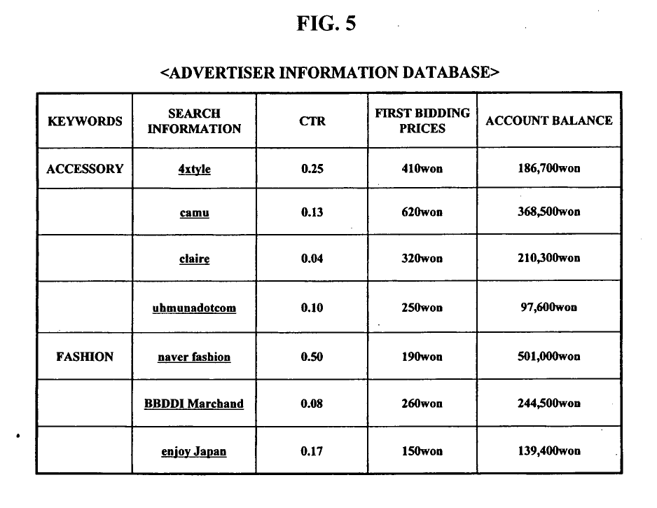

FIG. 5 is a diagram explaining various types of information corresponding to each search information stored on the basis of a keyword and including CTR, as another example of an advertiser information database according to embodiments of the present invention.

The advertiser information database 210 of FIG. 5 stores CTR, first bidding prices, and information on the account balance, with respect to search information grouped on the basis of keyword. In this instance, CTR indicates the ratio of the number of times that the user 120 selects a particular search information with respect to the number of times that the search information included in a search result list is displayed to the user 120, for a predetermined period. Namely, CTR measures the user's 120 clicks on search information displayed as search results, which makes it possible to know how popular corresponding search information is. A period for measuring CTR may be arbitrarily set by an operator of the present system considering a system environment. For example, the period may be set from a point in time when a keyword service of corresponding search information is initially registered to a current time.

Referring to FIG. 5, the advertiser information database 210 stores search information ‘4xtyle’ that is grouped on the basis of keyword ‘accessory’. In this case, CTR ‘0.25’, first bidding price ‘410 won’, and account balance ‘186,700 won’ are stored in association with the search information ‘4xtyle’.

FIG. 7 is a diagram illustrating an example of a search information database storing a search result list displaying search information in order of extraction rankings determined by a bidding process according to embodiments of the present invention.

The account balance adjusting system 200 determines an extraction ranking of each search information by referring to the advertiser information database 210. In the embodiment of FIG. 7, the extraction ranking of each search information is determined according to a predetermined numerical value outputted by multiplying CTR by a first bidding price.

In the case of ‘4xtyle’, the account balance adjusting system 200 may output numerical value ‘102.5(=0.25×410)’ by multiplying CTR ‘0.25’ by first bidding price ‘410 won’. Also, the account balance adjusting system 200 may determine an extraction ranking of the search information ‘4xtyle’ as a first place through comparison between numerical values with respect to other search information. Also, the account balance adjusting system 200 generates a search result list displaying corresponding search information according to the determined extraction ranking. As illustrated in FIG. 7, the account balance adjusting system 200 may control the search information ‘4xtyle’ having extraction ranking ‘1^{st} place’ to be displayed in the highest place on a search screen.

In particular, the account balance adjusting system 200 may store the first bidding price used for calculation in the search information database 250, in association with search information displayed in the search result list. Accordingly, the account balance adjusting system 200 may calculate advertising cost from a first point in time to just prior to a second point in time on the basis of the first bidding price stored in the search information database 250. In this case, the first point in time is when search information is extracted and the second point in time is when next search information is extracted.

According to embodiments of the present invention, a bidding price inputted from the advertiser 130 is updated in real time in the advertiser information database 210. Also, advertising cost is calculated by using a bidding price associated with a bidding process and the calculated advertising cost is controlled to be maintained until a point in time for the next bidding process. Accordingly, the system ability to estimate cost with respect to a payment process may be improved by allowing the advertiser 130 to arbitrarily input a bidding price and applying currently calculated advertising cost until just prior to a point in time for the next bidding process.

The operation flow of the account balance adjusting system 200 configured as above according to embodiments of the present invention will be described in detail.

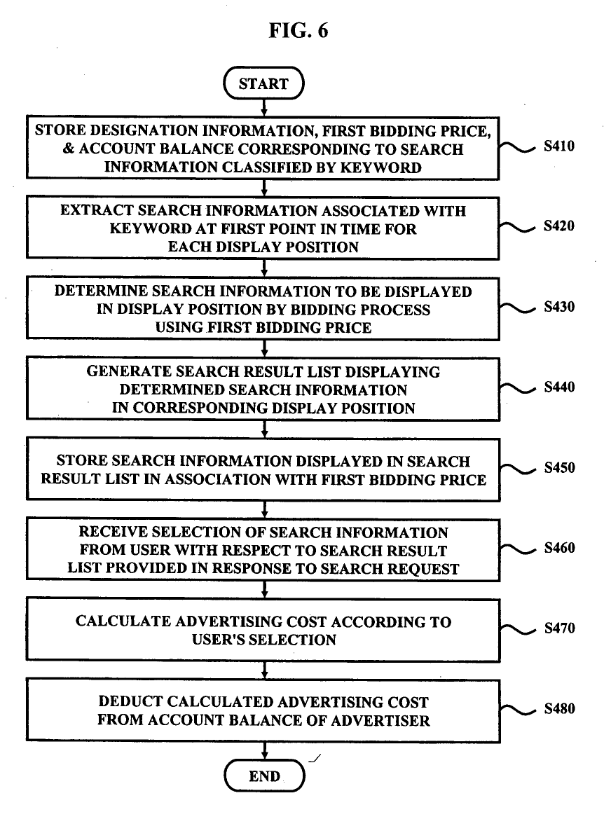

FIG. 6 is a flowchart explicitly illustrating an account balance adjusting method according to an exemplary embodiment of the present invention.

The account balance adjusting method is performed by the aforementioned account balance adjusting system 200.

In step S410, the account balance adjusting system 200 maintains the advertiser information database 210 including a keyword, search information associated with the advertiser 130, designation information with respect to a display position, a first bidding price, and the account balance of the advertiser 130. This step S410 is a procedure for grouping and storing at least one search information on the basis of a keyword causing extraction of search information. In this instance, each search information is associated with designation information and a first bidding price used for a bidding process, and information on the account balance for maintaining a keyword advertising service of corresponding search information. The designation information, the first bidding price, and information on the change of the account balance may be inputted from the advertiser 130 or an operator of the present system, and updated in real time in the advertiser information database 210.

In step S420, the account balance adjusting system 200 extracts at least one search information associated with a predetermined keyword for each display position at a first point in time, on the basis of the designation information. This step S420 is a procedure for extracting at least one search information at a first point in time when a bidding process is performed. In this instance, the search information may be displayed to the user 120 as search results in response to a search request. Namely, the search information is stored in the advertiser information database 210 on the basis of a keyword included in the search request. In this step S420, the account balance adjusting system 200 classifies and extracts search information having common designation information. Accordingly, an independent bidding process is performed for each display position.

In step S430, the account balance adjusting system 200 determines one search information displayed in each display position through a predetermined bidding process using the first bidding price with respect to the extracted search information. This step S430 is a procedure for performing an independent bidding process for each display position. One search information is determined through comparison between first bidding prices with respect to at least one search information having the same designation information on a particular display position (see FIG. 4). In this step S430, the account balance adjusting system 200 may compare only the size of a first bidding price. Also, the account balance adjusting system 200 may determine search information on the basis of a numerical value outputted by applying predetermined weight according to a system environment to the first bidding price.

Namely, a bidding process by the account balance adjusting system 200 is to extract a bidding price (first bidding price) with respect to at least one search information having the same designation information from the advertiser information database 210, and control search information of the highest numerical value to be determined through comparison between numerical values calculated by applying predetermined weight to the extracted bidding price. In this instance, the weight is multiplied to each search information and arbitrarily set by an operator of the present system. Namely, the weight may be set as more than 1 by considering an advertising period of search information, popularities thereof, and the like. Accordingly, a bidding process for search information is performed on the basis of not only comparison between bidding prices, but also various data with respect to the search information.

In step S440, the account balance adjusting system 200 generates a search result list displaying the determined search information in a corresponding display position. This step S440 is a procedure for generating a search result list displayed to the user 120 as search results in response to a predetermined search request. Accordingly, the account balance adjusting system 200 displays search information determined through a bidding process in a corresponding display position and generates the search result list.

In step S450, the account balance adjusting system 200 maintains the first bidding price associated with the determined search information and the generated search result list associated with the keyword in the search information database 250. This step S450 is a procedure for recording a bidding price used for a bidding process in the search information database 250 together with a search result list. Accordingly, the first bidding price recorded in association with the search result list is maintained in the search information database 250 until a point in time (second point in time) when the next search information is extracted. Accordingly, advertising cost occurring between the first point in time and the second point time may be controlled to be calculated on the basis of the first bidding price.

In step S460, the account balance adjusting system 200 receives a selection of search information from the user 120 with respect to the search result list provided to the user 120 in response to the user's 120 search request including the keyword. This step S460 is a procedure for displaying a search result list to the user 120 as search results for a search request and receiving the user's 120 click on particular search information displayed on the search result list. In this case, the search engine 110 connects the user 120 to the advertiser's 130 web page by using predetermined link information of the clicked search information and provides the user 120 with information of the advertiser 130. In this manner, predetermined advertising effects may be displayed for the user 120.

In step S470, the account balance adjusting system 200 calculates predetermined advertising cost in association with the user's 120 selection. This step S470 is a procedure for calculating advertising cost to be charged to the advertiser 130 in association with the user's 120 click on search information. In this instance, the advertising cost is calculated by using a first bidding price recorded in the search information database 250. In particular, in this step S470, the account balance adjusting system 200 maintains the first bidding price in the search information database 250 just prior to the second point in time when the next bidding process is performed. Accordingly, the calculated advertising cost may be continuously used for a predetermined period. Hereinafter, an example of calculating advertising cost will be described with reference to FIG. 11.

FIG. 11 is a flowchart illustrating an example of a method for selecting a bidding price associated with calculation of advertising cost according to embodiments of the present invention.

In step S471, in the case the user's 120 selection is inputted before the second point in time passes from the first point in time, the account balance adjusting system 200 searches for a first bidding price associated with the selected search information by referring to the search information database 250. This step S471 is a procedure for controlling advertising cost occurring in association with the user's 120 selection which is calculated on the basis of the first bidding price stored in the search information database 250, irrespective of a new bidding price (second bidding price). In this instance, the new bidding price is inputted from the advertiser 130 before the second point time passes from the first point in time. Namely, the account balance adjusting system 200 updates the advertiser's 130 second bidding price, which is inputted from the advertiser 130 before the second point in time passes from the first point in time, only in the advertiser information database 210. The account balance adjusting system 200 maintains the size of a bidding price from the first point in time until just before the second point in time, with respect to the first bidding price of the search information database 250. In this instance, the first bidding price is associated with calculation of advertising cost.

In step S472, the account balance adjusting system 200 calculates advertising cost by using the retrieved first bidding price. This step S472 is a procedure for calculating advertising cost with respect to predetermined advertising effects by using the first bidding price at the first point in time stored in the search information database 250. In this step S472, advertising cost to be charged to the advertiser 130 is determined in association with the user's 120 selection on search information displayed as search results.

In the present embodiment, advertising cost may be at least one of predetermined cost per display according to providing the user 120 with a search result list including the search information, predetermined cost per purchase according to a successfully completed purchase by the user 120 who has been connected to an advertiser, and cost per click according to an one-time click of the user 120 with respect to the search information. The advertising cost described above may be determined by using the first bidding price stored in the search information database 250. Besides the first bidding price, cost according to a one-time display or a predetermined ratio of purchase cost may be determined as advertising cost.

Referring again to FIG. 6, in step S480, the account balance adjusting system 200 deducts the calculated advertising cost from the account balance of the advertiser 130 of the selected search information. This step S480 is a procedure for deducting advertising cost from the account balance of an advertiser 130 in association with a one-time click of the user 120 with respect to the search information. It may be preferable that a payment of advertising cost is performed in real time in association with the user's 120 selection. Also, as another embodiment, it is possible to accumulate the number of times that the user 120 selects search information, and deduct advertising cost with respect to the number of selections in one lump at a certain point in time.

According to embodiments of the present invention, ability to estimate with respect to calculation of advertising cost may be guaranteed by maintaining advertising cost charged to the advertiser 130 for a predetermined period. Also, embodiments of the present invention allow the advertiser 130 to input a bidding price in real time and periodically calculate advertising cost. Accordingly, it is possible to save system resources used in calculating the advertising cost.

As another embodiment of the present invention, allowing the advertiser 130 to input a new bidding price in real time will be described.

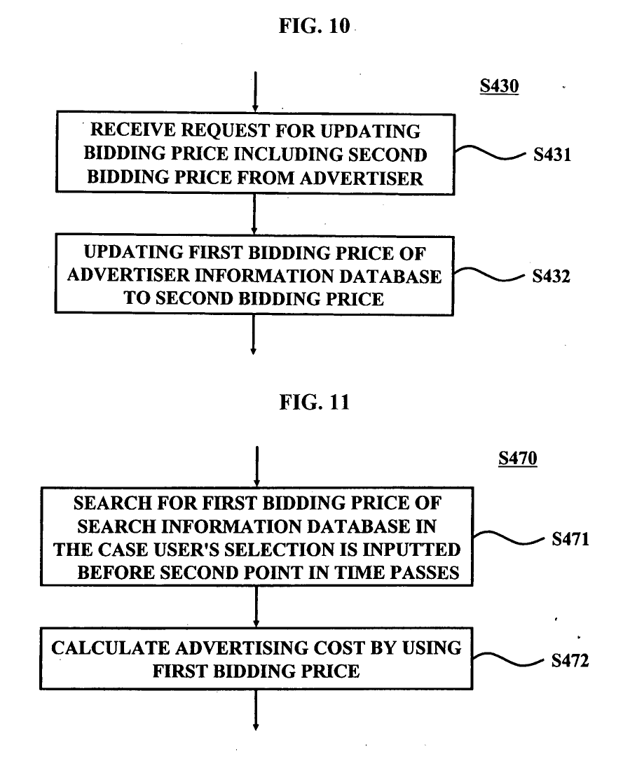

FIG. 10 is a flowchart illustrating an example of a method for updating a second bidding price inputted from an advertiser 130 according to embodiments of the present invention.

The embodiments of the present invention updates and stores a first bidding price of the advertiser information database 210 in the amount of a corresponding bidding price, in real-time in response to a modification signal with respect to a bidding price inputted from the advertiser 130. For this, in step S431, the account balance adjusting system 200 receives a request for updating a bidding price including a second bidding price from the advertiser 130. Namely, in this step S431, the account balance adjusting system 200 determines whether the advertiser 130 requests to change the first bidding price recorded in the advertiser information database 210.

In step S432, the account balance adjusting system 200 updates the first bidding price recorded in the advertiser information database 210 to the second bidding price in real time, in response to the updating request. This step S432 is a procedure for updating the first bidding price only in the advertiser information database 210 according to a bidding price inputted from the advertiser 130. In this instance, the advertiser's 130 second bidding price is not related to the first bidding price of the search information database 250.

According to embodiments of the present invention, it is possible to meet the advertiser's 130 requests with respect to change of a bidding price. Also, advertising cost calculated by using a bidding price is maintained for a certain period. Accordingly, it is possible to guarantee the ability to estimate advertising cost and save system sources.

Hereinafter, as another embodiment of the present invention, extracting search information on the basis of a bidding price and CTR and determining a display position in a search result list displaying the extracted search information will be described.

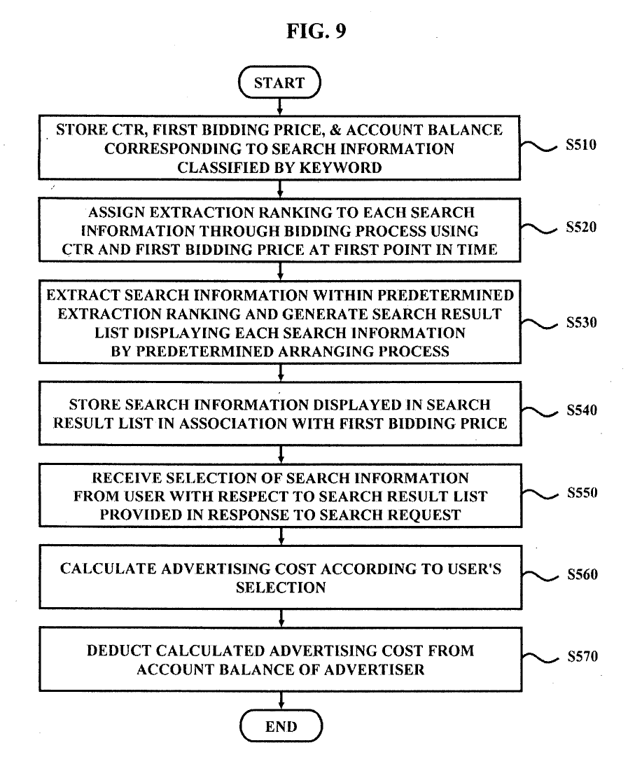

FIG. 9 is a flowchart illustrating another embodiment of an account balance adjusting system according to embodiments of the present invention.

In step S510, the account balance adjusting system 200 maintains the advertiser information database 210 including a keyword, search information associated with the advertiser 130, CTR with respect to search information, a first bidding price, and the account balance of the advertiser 130. This step S510 is a procedure for calculating CTR corresponding to a predetermined period to output an extracted ranking, and recording the calculated CTR in the advertiser information database 210 (see FIG. 5). In this instance, CTR indicates as a percentage the number of times that the user 120 selects predetermined search information with respect to the number of times that the search information is included in a search result list and provided in response to a search request, for a predetermined period. Also, CTR is used to know how popular particular search information is among users 120.

In step S520, the account balance adjusting system 200 identifies at least one search information associated with a keyword at a first point in time, and assigns an extraction ranking to the identified search information through a predetermined bidding process using the first bidding price and CTR. This step S520 is a procedure for outputting a numerical value calculated by multiplying the first bidding price stored in the advertiser information database 210 by a corresponding CTR. An extraction ranking with respect to each search information is determined in a certain order according to the calculated numerical value. In this instance, the extraction ranking is an order of search information to be extracted prior to another search information, in response to a search request. Also, the extraction ranking may be associated with a determination of a display position where search information is displayed in a search result list. Namely, search information of a comparatively higher extraction ranking may be controlled to be displayed in a comparatively higher position on a search screen. In the present embodiment, it is limited and described that a bidding process is to calculate a numerical value by multiplying a first bidding price by CTR and determine an extraction ranking with respect to each search information through comparison between the calculated numerical values. However, also, a first bidding price with respect to at least one search information identified by a keyword inputted from the user 120 and CTR may be extracted from the advertiser information database 210. A numerical value may be calculated by applying a weight to the extracted first bidding price and CTR. A comparatively higher extraction ranking may be controlled to be assigned to search information of the highest numerical value. The weight may be arbitrarily determined by an operator of the present system considering a system environment.

In step S530, the account balance adjusting system 200 extracts search information within a predetermined extraction ranking and generates a search result list displaying the extracted search information in a predetermined display position according to a predetermined arranging process. This step S530 is a procedure for selecting search information within a certain extraction ranking from the highest ranking and sequentially displaying the search information from the highest position in a search result list and continues in descending order of extraction rankings. Namely, the arranging process is a process where a signal initiates a process of displaying search information having a higher extraction ranking in a display position where the user 120 may easily recognize, such as in a display position where popularity is comparatively higher (see FIG. 7).

In step S540, the account balance adjusting system 200 maintains the first bidding price associated with the extracted search information and the generated search result list associated with the keyword in the search information database 250. Also, in step S550, the account balance adjusting system 200 receives a selection of search information from the user 120 with respect to the search result list provided to the user 120 in response to the user's 120 search request including the keyword. In step S560, the account balance adjusting system 200 calculates advertising cost in association with the selection. In step S570, the account balance adjusting system 200 deducts the calculated advertising cost from the account balance of the advertiser 130 of the selected search information. These steps S540 through S570 are similar to or the same as the steps S450 through S480 of FIG. 6. Accordingly, detailed description related thereto will be omitted herein.

In particular, in step S560 of calculating advertising cost, in the case the user's 120 selection is inputted before the second point in time passes from the first point in time, the account balance adjusting system 200 searches for a first bidding price associated with the selected search information by referring to the search information database 250 and calculates advertising cost by using the retrieved first bidding price.

According to embodiments of the present invention, search information to be displayed as search results in response to a search request is selected on the basis of a bidding price and CTR for a predetermined period. Accordingly, it is possible to generate a search result list in which popularity according to a plurality of users with respect to search information is reflected.

Also, the account balance adjusting system 200 may receive a request for updating a bidding price including a second bidding price from the advertiser 130 and update the first bidding price recorded in the advertiser information database 210 to the second bidding price in real time in response to the updating request. Also, a bidding process at a second point in time is performed by using a second bidding price updated just prior to the second point in time or a first bidding price not updated because no new bidding price is inputted, and CTR. In this instance, the second point in time is when the next bidding process is performed.

According to embodiments of the present invention, while the advertiser 130 is allowed to input a new bidding price, advertising cost calculated at a first point in time is maintained and applied for a payment until a point time when the next bidding process is performed. Accordingly, it is possible to guarantee the ability to estimate advertising cost and effectively save system resources used to calculate advertising cost.

Hereinafter, as another embodiment of the present invention, selecting N of search information on the basis of a predetermined numerical value calculated by multiplying a bidding price and CTR and displaying the selected search information on a search result list in random order will be described.

For this, the account balance adjusting system 200 stores a first bidding price and CTR in the advertiser information database 210 in association with search information. The first bidding price is received from the advertiser 130 who has registered search information to a keyword advertising provider. Also, CTR is determined on the basis of the number of times that the search information is provided to a user for a predetermined period and the number of times that the user clicks the provided search information. As described above, the first bidding price is associated with the maximum amount of money that the advertiser 130 is willing to pay as advertising cost. CTR is data showing popularity with respect to corresponding search information for a predetermined period.

Also, the account balance adjusting system 200 outputs a predetermined numerical value calculated by multiplying a first bidding price by CTR for each search information, and selects N of search information through a bidding process based on the calculated numerical values, that is, through comparison between the calculated numerical values. In this instance, N may be determined by considering a number of search information displayed on a search result list provided to the user 120 as search results.

The account balance adjusting system 200 arranges the selected search information in random order and generates a search result list with respect to the keyword.

The account balance adjusting system 200 provides the generated search result list to the user 120 in response to the user's 120 search request. The search result list transmitted to the user 120 is displayed on a screen via a web browser of the terminal 125 of the user 120.

Also, the account balance adjusting system 200 receives a selection of search information from the user 120 with respect to search information displayed in the search result list and calculates predetermined advertising cost in association with the selection. In particular, as an example for calculating advertising cost with respect to search information, embodiments of the present invention may generate advertising cost per click on search information and charge the generated advertising cost to an advertiser 130. In this case, the advertising cost may be charged equally with respect to the selected N of search information. Namely, in embodiments of the present invention, it is possible to guarantee the equivalent display frequency or number of clicks with respect to search information included in N. Accordingly, it may be preferable that reasonable advertising cost is equally applied and charged to an advertiser 130 without charging different advertising cost according to a bidding price of search information. Namely, according to embodiments of the present invention, the reason why an advertiser allots a high bidding price may be interpreted not to display his/her search information in the highest extraction ranking, but to have more opportunities to be displayed to users 120 by making his/her search information selected by a number of users 120 and randomly arranged. Also, as an example of unit advertising cost, the unit advertising cost may be calculated on the basis of cost per click ranking an N+1 place among bidding prices received from the advertiser 130. More specifically, an additional amount of money added to a predetermined amount (e.g., +10 won) may be calculated as advertising cost to be slightly higher than a bidding price ranking an N+1 place. This is to maintain balance with the advertiser 130 who has suggested a bidding price of an N+1 place.

Also, the account balance adjusting system 200 deducts the calculated advertising cost from the account balance of the advertiser 130 of the selected search information.

According to embodiments of the present invention, each display position of search information in a search result list is determined according to a numerical value calculated on the basis of a bidding price and CTR. Search information arranged in the determined display position is provided to a user 120 as search results for the user's 120 search request. Accordingly, an advertiser 130 who maintains a higher bidding price or popularity may achieve good advertising effects.

In the meantime, in the case a request for updating a bidding price including a second bidding price is received from an advertiser 130, the account balance adjusting system 200 updates a first bidding price recorded in the advertiser information database 210 to the second bidding price in real time, in response to the updating request.

In this instance, the bidding process for generating a search result list with respect to the keyword occurs at a second point in time when a predetermined period time passes from the first point in time. Accordingly, even in the case the first bidding price is updated to the second bidding price in real time according to the request for updating the bidding price, the search result list does not change by the second point in time.

Accordingly, the search result list generated by using the first bidding price, not the second bidding price, is provided to a user 120 before the second point in time. Also, in the case the user 120 selects search information, advertising cost is calculated by using the first bidding price.

Namely, according to embodiments of the present invention, an advertiser may update a bidding price in real time. On the other hand, a search result list may be periodically updated. Until the search result list is updated, advertising cost is calculated on the basis of a previous bidding price. Accordingly, it is possible to reasonably charge advertising cost to an advertiser 130.

The account balance adjusting method according to embodiments of the present invention includes computer readable media including program instructions to implement various operations embodied by a computer. The media may also include, alone or in combination with the program instructions, data files, data structures, tables, and the like. The media and program instructions may be those specially designed and constructed for the embodiments of the present invention, or they may be of the kind well known and available to those having skill in the computer software arts. Examples of computer-readable media include magnetic media such as hard disks, floppy disks, and magnetic tape; optical media such as CD ROM disks; magneto-optical media such as floptical disks; and hardware devices that are specially configured to store and perform program instructions, such as read-only memory devices (ROM) and random access memory (RAM). The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter.

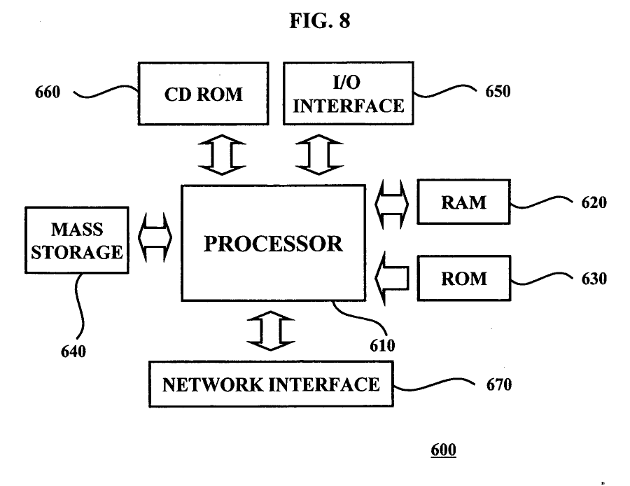

FIG. 8 is an internal block diagram of a general-purpose computer which can be more adopted in implementing the account balance adjusting method according to embodiments of the present invention.

FIG. 8 is a block diagram illustrating a computer apparatus 600 which includes at least one processor 610 connected to a main memory device including RAM (Random Access Memory) 620 and ROM (Read Only Memory) 630. The processor 610 is also known as a central processing unit CPU. As well-known in the field of the art, the ROM 630 unidirectionally transmits data and instructions to the CPU, and the RAM 620 is generally used for bidirectionally transmitting data and instructions. The RAM 620 and the ROM 630 may include a certain proper form of a computer readable recording medium. A mass storage device 640 is bidirectionally connected to the processor 610 to provide additional data storage capacity and may be one of number of computer readable recording mediums. The mass storage device 640 is used for storing programs and data and is an auxiliary memory. A particular mass storage device such as a CD ROM 660 may be used. The processor 610 is connected to at least one input/output interface 650 such as a video monitor, a track ball, a mouse, a keyboard, a microphone, a touch-screen type display, a card reader, a magnetic or paper tape reader, a voice or hand-writing recognizer, a joy stick, or other known computer input/output unit. The processor 610 may be connected to a wired or wireless communication network via a network interface 670. The procedure of the described method can be performed via the network connection. The described devices and tools are well-known to those skilled in the art of computer hardware and software.

The hardware elements above may be configured to act as one or more software modules for implementing the operations of embodiments of this invention.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching.

Therefore, it is intended that the scope of the invention be defined by the claims appended thereto and their equivalents.

Although the present invention has been described in connection with the embodiment of the present invention illustrated in the accompanying drawings, it is not limited thereto since it will be apparent to those skilled in the art that various substitutions, modifications and changes may be made thereto without departing from the scope and spirit of the invention.

As described above, according to the present invention, there is provided a method and system for adjusting an account balance, which can optimally save system resources spent in calculating advertising cost by receiving a new bidding price from an advertiser in real time and applying advertising cost to a payment process generating within a certain period. In this instance, the advertising cost is calculated by using a bidding price in a predetermined point in time.

Also, according to the present invention, there is provided a method and system for adjusting the account balance, which can meet an advertiser's demands for modification with respect to a bidding price in real time by updating the advertiser's new bidding price in a short time.

Also, according to the present invention, there is provided a method and system for adjusting the account balance, which can more reasonably charge advertising cost by charging pre-calculated advertising cost to an advertiser in association with a user's click occurring between time intervals when a bidding process with respect to search information is performed.

What is claimed is:

1. A method of running an advertisement service associated with a search using a search term, the method comprising:
transmitting an offer for a bid for a search term for an advertisement service using the search term, wherein the advertisement service involves displaying a search result page configured to display a dynamic link configured to open a designated page and a result of a search conducted using the search term in reply to a request for the search; and
receiving a first bid for the advertisement service using the search term for a first period, wherein the first bid comprises a first rate to be charged to a first account associated with the first bid for each opening of a first designated page from a search result page when the opening of the first designated page occurs during the first period, wherein the first rate is to be maintained during the first period.

2. The method of claim 1, further comprising receiving a second bid for the advertisement service using the search term, wherein the second bid comprises a second rate to be charged for each opening of the first designated page from a search result page, wherein the second bid is received prior to expiration of the first period, wherein the second rate is not to supersede the first rate for the remainder of the first period.

3. The method of claim 2, wherein the second rate is to be charged for each opening of the first designated page from a search result page that occurs during a second period following the first period.

4. The method of claim 1, further comprising transmitting data indicative of the acceptance of the first bid.

5. The method of claim 1, further comprising:
receiving a second bid for the advertisement service using the search term for a second period overlapping with the first period, wherein the second bid comprises a second rate to be charged to a second account associated with the second bid for each opening of a second designated page from a search result page when the opening of the first designated page occurs during the second period;
determining that the first rate is greater than the second rate; and
prioritizing the first bid and the second bid based on the determination so as to display a first dynamic link for the first designated page and a second dynamic link for the second designated page in a manner the first dynamic link appears more conspicuously than or above the second dynamic link on a search result page.

6. The method of claim 1, further comprising:
receiving, from a terminal, a search request for conducting a database search or an Internet search using the search term;
transmitting, to the terminal, data for displaying a search result page comprising a search result and a first dynamic link to open the first designated page;
monitoring opening of the first designated page from the search result page; and
charging, to the first account, the first rate upon confirming an opening of the first designated page from the search result page.

7. The method of claim 1, further comprising charging, to an account associated with the first bid, an amount calculated based on the first rate for openings of the first designated page from search result pages created from searches using the search term, wherein the openings occur during the first period.

8. The method of claim 7, wherein the calculated amount is deducted from a balance of the account.

9. A method of arranging for an advertisement in a search result page in reply to a search request using a search term, the method comprising:
receiving, at a terminal, an offer for a bid for a search term for an advertisement service using the search term, wherein the advertisement service involves displaying a search result page comprising a dynamic link configured to open a designated page and a result of a search conducted using the search term in reply to a request for the search; and
transmitting, from the terminal, a first bid for the advertisement service using the search term for a first period, wherein the first bid comprises a first rate to be charged to an account associated with the first bid for each opening of a first designated page from a search result page when the opening of the first designated page occurs during the period, wherein the first rate is to be maintained during the period.

10. The method of claim 9, further comprising submitting a second bid for the advertisement service using the search term for opening the first designated page, wherein the second bid comprises a second rate to be charged for each opening of the first designated page from a search result page, wherein the second bid is submitted prior to expiration of the first period, wherein the second rate is not to supersede the first rate for the remainder of the first period.

11. The method of claim 10, wherein the second rate is to be charged for each opening of the first designated page from a search result page that occurs during a second period following the first period.

12. The method of claim 11, further comprising receiving an electronic notification of charging of an amount calculated based on the first rate and a count of opening of the first designated page during the first period from search result pages created from searches using the search term.

13. A method of running an advertisement service associated with a search using a search term, the method comprising:
receiving, from a terminal, a search request for conducting a search using a search term;
conducting a database search or an Internet search using the search term;
transmitting, to the terminal, data for displaying a search result page comprising a search result and a dynamic link configured to open a designated page;
monitoring opening of the designated page from the search result page by activating the dynamic link;
charging, to an account associated with the designated page, the rate upon confirming an opening of the designated page from the search result page,
wherein the rate is fixed during a predetermined period.

14. The method of claim 13, further comprising:
calculating an advertisement charge using the rate and the number of opening the page from the search result page during the fixed period,
wherein charging comprises deducting the rate from a balance of the account.

15. The method of claim 14, further comprising, to the account, an amount calculated based on the rate for a plurality of openings of the designated page from search result pages displaying the dynamic link for the designated page when each of the plurality of openings occur during the fixed period.

16. The method of claim 14, wherein charging comprises adding the rate to and existing advertisement charge for each opening of the designated page.

17. The method of claim 14, wherein monitoring the opening of the designated page comprises receiving a notification from the terminal that the designated page is opened by activating the dynamic link by opening the page through the search result page.

18. The method of claim 14, wherein monitoring the opening of the designated page comprises determining whether any data is transmitted from a computer associated with the designated page to the terminal.
